(19) United States
(12) Patent Application Publication
(10) Pub. No.: US 2015/0063749 A1
(43) Pub. Date: Mar. 5, 2015

(54) LENS UNIT AND OPTICAL COMMUNICATION DEVICE

(71) Applicant: HON HAI PRECISION INDUSTRY CO., LTD., New Taipei (TW)

(72) Inventor: YI HUNG, Tu-Cheng (TW)

(73) Assignee: HON HAI PRECISION INDUSTRY CO., LTD., New Taipei (TW)

(21) Appl. No.: 14/093,054

(22) Filed: Nov. 29, 2013

(30) Foreign Application Priority Data
Aug. 27, 2013 (TW) 102130524

(51) Int. Cl. G02B 6/32; G02B 17/00

(52) U.S. Cl. CPC G02B 6/32; G02B 17/00
USPC 385/33; 359/726

(57) ABSTRACT

A lens unit includes first and second portions. The first and second portions share a common bottom surface and a common first side surface perpendicular to the bottom surface. The first portion includes a first reflecting surface. An included angle between the first reflecting surface and the bottom surface is 45 degrees, and an included angle between the first reflecting surface and the first side surface is 45 degrees. The second portion comprises a second side surface parallel to the first side surface, a second reflecting surface, a third reflecting surface, and a fourth reflecting surface. The fourth reflecting surface is parallel to the third reflecting surface. An included angle between the second reflecting surface and the first side surface is 45 degrees. An included angle between the third reflecting surface and the second side surface is 45 degrees.

### BACKGROUND

1. Technical Field

The present disclosure relates to a lens unit and an optical communication device having the lens unit.

2. Description of Related Art

Optical communication devices include optical fibers, light-emitting units, a lens unit, and light-receiving units. The lens unit is configured for coupling the optical fibers to the light-emitting units and the light-receiving units

Light emitted by the light-emitting units travels a certain distance in the lens unit before being coupled to the optical fibers. Light emitted by the optical fibers travels the same distance in the lens unit before being coupled to the light-receiving units. Thus, the lens unit only allows the light to travel a same distance when it is emitted and received. When the optical communication device needs light to travel different distances in the lens unit, two or more lens units are needed, thereby increasing a size of the optical communication device.

Therefore, it is desirable to provide a lens unit and an optical communication device which can overcome the limitation described.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is a schematic view of an embodiment of an optical communication device.

FIG. 2 is an exploded view of the optical communication device of FIG. 1.

FIG. 3 is another exploded view of the optical communication device of FIG. 1.

FIG. 4 is a front side view of the optical communication device of FIG. 2.

FIG. 5 is a back side view of the optical communication device of FIG. 2.

### DETAILED DESCRIPTION

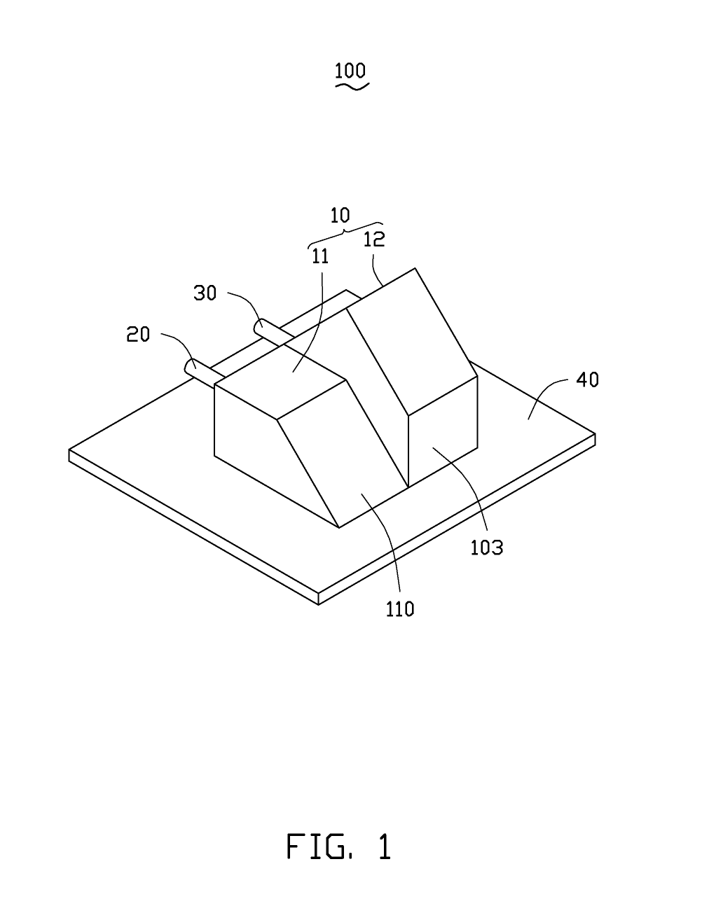

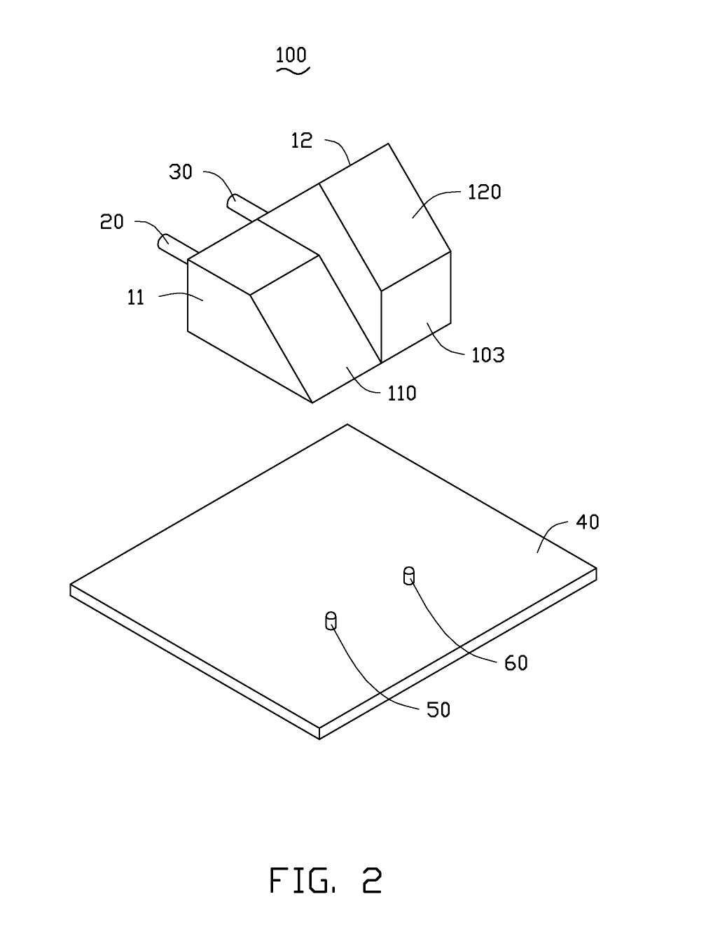

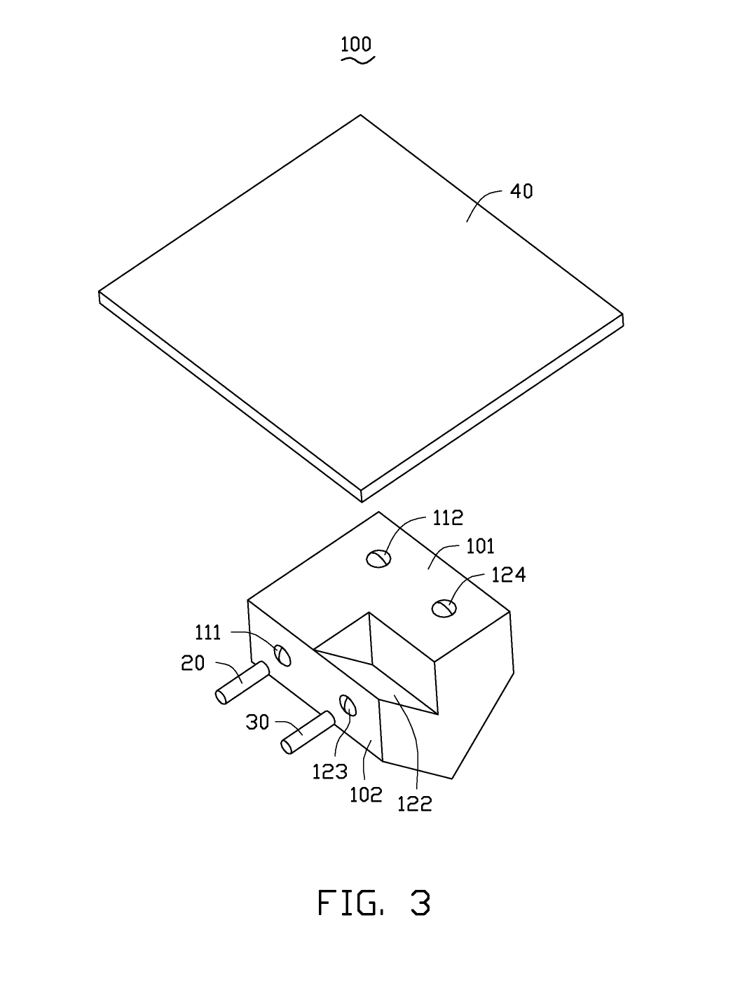

FIGS. 1-3 show an exemplary embodiment of an optical communication device 100. The optical communication device 100 includes a lens unit 10, a first optical fiber 20, a second optical fiber 30, a circuit board 40, a first photoelectric unit 50, and a second photoelectric unit 60.

The circuit board 20 can be a hard circuit board or a flexible circuit board. The first photoelectric unit 50 and the second photoelectric unit 60 are located on and electrically connected to the circuit board 20. In this embodiment, both the first photoelectric unit 50 and the second photoelectric unit 60 are light-emitting units. In other embodiment, both the first photoelectric unit 50 and the second photoelectric unit 60 are light-receiving units. In another embodiment, one of the first photoelectric unit 50 and the second photoelectric unit 60 is a light-emitting unit and the other one is a light-receiving unit. The light-emitting unit can be a light-emitting diode or a laser diode. The light-receiving unit is a photodiode. The lens unit 20 is configured for coupling the first optical fiber 20 to the first photoelectric unit 50, and the second optical fiber 30 to the second photoelectric unit 60.

The lens unit 10 includes a first portion 11 and a second portion 12. The first portion 11 is configured for coupling the first optical fiber 20 to the first photoelectric unit 50. The second potion 12 is configured for coupling the second optical fiber 30 to the second photoelectric unit 60.

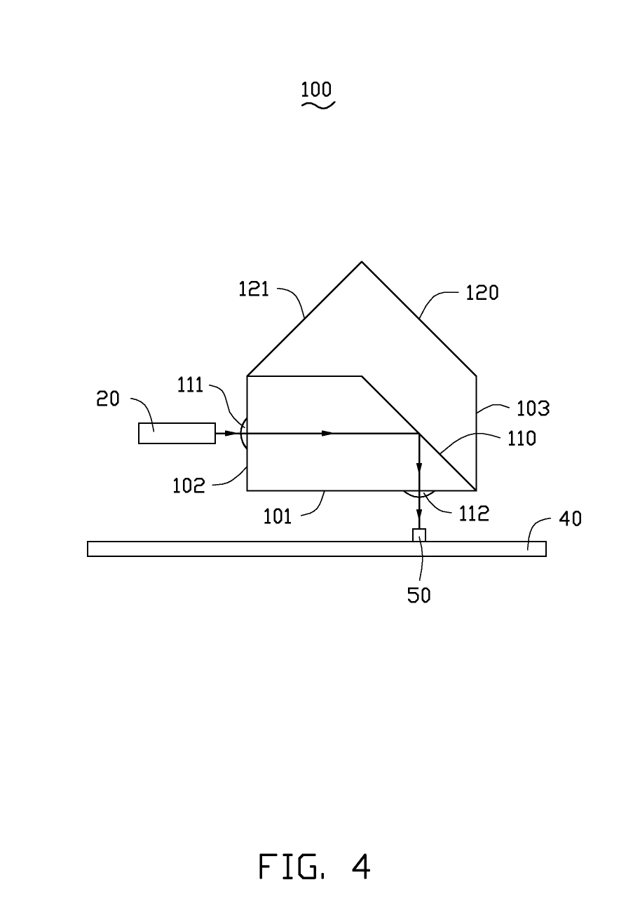

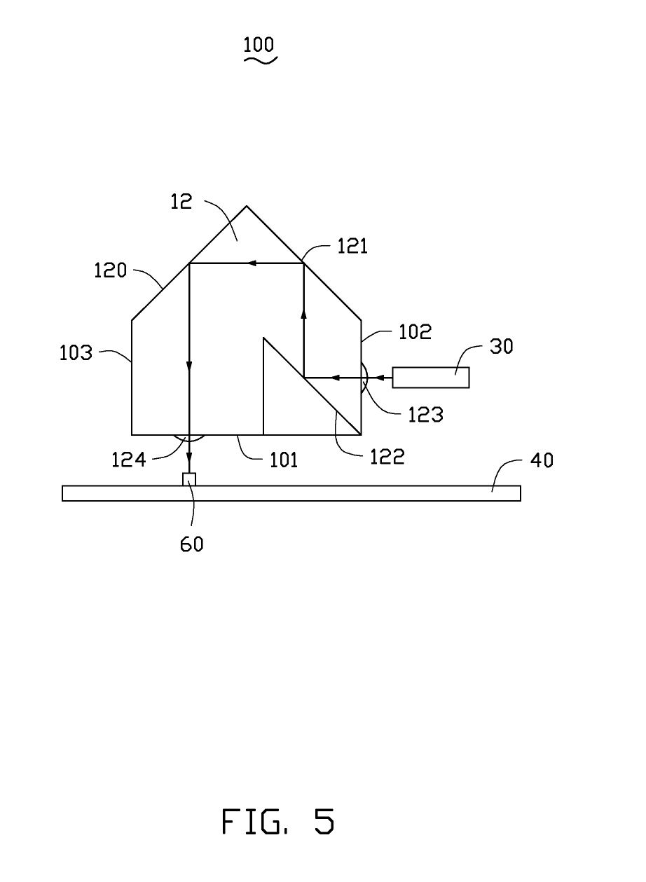

Referring to FIGS. 4 and 5, the first portion 11 and the second portion 12 share a common bottom surface 101 and a common first side surface 102. The first side surface 102 is substantially perpendicular to the bottom surface 101. The first side surface 102 defines a first lens 111 and a third lens 123. An optical axis of the first lens 111 is substantially parallel to an optical axis of the third lens 123 and substantially perpendicular to the first side surface 102. The bottom surface 101 defines a second lens 112 and a fourth lens 124. An optical axis of the second lens 112 is substantially parallel to an optical axis of the fourth lens 124 and substantially perpendicular to the bottom surface 101. The first lens 111 and the second lens 112 are located on the first portion 11. The third lens 123 and the fourth lens 124 are located on the second portion 12.

The first portion 11 also includes a first reflecting surface 110. An included angle between the first reflecting surface 110 and the bottom surface 101 is about 45 degrees. An included angle between the first reflecting surface 110 and the first side surface 102 is also about 45 degrees.

The second portion 12 also includes a second side surface 103, a second reflecting surface 120, a third reflecting surface 121, and a fourth reflecting surface 122. The second side surface 103 is substantially parallel to the first side surface 102. The second reflecting surface 120, the third reflecting surface 121, and the fourth reflecting surface 122 are between the first side surface 102 and the second side surface 103. The second reflecting surface 120 is substantially perpendicular and connects to the third reflecting surface 121. An included angle between the second reflecting surface 120 and the second side surface 103 is 135 degrees. The fourth reflecting surface 122 is substantially parallel to the third reflecting surface 121. An included angel between the third reflecting surface 121 and the first side surface 102 is 135 degrees. The fourth reflecting surface 122 extends obliquely from the bottom surface 101 toward an inner middle space of the lens unit 10. An included angle between the fourth reflecting surface 122 and the bottom surface 101 is about 45 degrees.

Referring to FIG. 4, light emitted by the first optical fiber 20 emits onto the first reflecting surface 110 of the first portion 11 through the first lens 111 of the first side surface 102. After the light is reflected by the first reflecting surface 110, the light exits from the first portion 11 through the second lens 112. The first photoelectric unit 50 receives the light.

Referring to FIG. 5, light emitted by the second optical fiber 30 emits onto the fourth reflecting surface 122 of the second portion 12 through the third lens 123 of the first side surface 102. The light is reflected onto the third reflecting surface 121. The light is then reflected onto the second reflecting surface 120, and subsequently reflected off the second reflecting surface 120 to exit from the second portion 12 through the fourth lens 124. The second photoelectric unit 60 receives the light.

Light emitted by the first optical fiber 20 is reflected one time in the first portion 11 and is received by the first photoelectric unit 50, but light emitted by the second optical fiber 30 is reflected three times in the second portion 12 and is received by the second photoelectric unit 60. Thus, light emitted by the first optical fiber 20 and the second optical fiber 30 have different optical lengths.

In other embodiments, both the first photoelectric unit 50 and the second photoelectric unit 60 are light-emitting units. Light emitted by the first photoelectric unit 50 is emitted onto the first reflecting surface 110 through the second lens 112. The light is reflected by the first reflecting surface 110 onto the first lens 111 to enter the first optical fiber 20. Light emitted by the second photoelectric unit 60 enters the second portion 12 through the fourth lens 124. The light is reflected by the second reflecting surface 120, the third reflecting surface 121, and the fourth reflecting surface 122 through the third lens 123 and onto the second optical fiber 30.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the disclosure.

What is claimed is:

1. A lens unit, comprising a first portion and a second portion connected with the first portion, wherein the first portion and the second portion comprises a common bottom surface and a common first side surface perpendicular with the bottom surface, the first portion comprises a first reflecting surface, an included angle between the first reflecting surface and the bottom surface is 45 degrees, an included angle between the first reflecting surface and the first side surface is 45 degrees, the second portion comprises a second side surface parallel to the first side surface, a second reflecting surface, a third reflecting surface, and a fourth reflecting surface, the third reflecting surface is perpendicular with the second reflecting surface and the fourth reflecting surface is parallel to the third reflecting surface, an included angle between the second reflecting surface and the second side surface is 135 degrees, an included angle between the third reflecting surface and the first side surface is 135 degrees, all of the second reflecting surface, the third reflecting surface, and the fourth reflecting surface cooperatively bent a light 90 degrees.

2. The lens unit of claim 1, wherein each of the bottom surface and the first side surface comprises a lens.

3. An optical communication device, comprising a lens unit, an optical fiber, and a photoelectric unit, the lens unit being configured for coupling the optical fiber to photoelectric unit, wherein the lens unit comprises a first portion and a second portion, the first portion and the second portion comprises a common bottom surface and a common first side surface perpendicular with the bottom surface, the first portion comprises a first reflecting surface, an included angle between the first reflecting surface and the bottom surface is 45 degrees, an included angle between the first reflecting surface and the first side surface is 45 degrees, the second portion comprises a second side surface parallel to the first side surface, a second reflecting surface, a third reflecting surface, and a fourth reflecting surface, the third reflecting surface is perpendicular with the second reflecting surface and the fourth reflecting surface is parallel to the third reflecting surface, an included angle between the second reflecting surface and the first side surface is 45 degrees, an included angle between the third reflecting surface and the second side surface is 45 degrees, all of the second reflecting surface, the third reflecting surface, and the fourth reflecting surface cooperatively bent a light 90 degrees.

4. The optical communication device of claim 3, comprising a circuit board, the photoelectric unit being located on and electrically connected to the circuit board.

5. The optical communication device of claim 4, wherein the circuit board is selected from the group consisting of hard circuit board and flexible circuit board.

6. The optical communication device of claim 3, wherein the photoelectric unit is selected from the group consisting of a light-emitting unit and a light-receiving unit.

7. The optical communication device of claim 3, wherein each of the bottom surface and the first side surface comprises a lens.
